(19) United States
(12) Patent Application Publication
(10) Pub. No.: US 2008/0161488 A1
(43) Pub. Date: Jul. 3, 2008

(54) Polyoxymethylene blends

(76) Inventor: Ramabhadra Ratnagiri, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/004,182

(22) Filed: Dec. 19, 2007

Related U.S. Application Data
(60) Provisional application No. 60/877,462, filed on Dec. 27, 2006.

(51) Int. Cl. C08L 61/00; C08L 61/02

(52) U.S. Cl. 524/593; 525/398

(57) ABSTRACT

Disclosed herein are polyoxymethylene blends having excellent fatigue resistance comprising at least one polyoxymethylene homopolymer having a number average molecular weight of at least about 100,000 and at least one polyoxymethylene homopolymer having a number average molecular weight between about 15,000 and about 30,000.

### CROSS-REFERENCE TO RELATED APPLICATION

This application claims the benefit of U.S. Provisional Application No. 60/877,462, filed Dec. 27, 2006, which is incorporated by reference herein in its entirety.

### FIELD OF THE INVENTION

The present invention relates to polyoxymethylene resin compositions having excellent fatigue and creep resistance and good mechanical properties.

### BACKGROUND OF THE INVENTION

Many applications require the use of parts that are in motion with respect to other parts with which they are in physical contact. Because polymeric materials often have light weight and good physical properties and can be used to form a large variety of shapes, they are often used in such applications. However, the materials must often have good wear and fatigue resistance, particularly over prolonged use. Polyoxymethylene (also known as POM or polyacetals) are known to have excellent tribology and good physical properties and good wear resistance.

Higher molecular weight polyoxymethylene often have improved fatigue resistance and physical properties such as impact strength and tensile properties relative to lower molecular weight variants. However, as polyoxymethylene increase in molecular weight, they become harder to process using conventional melt processing techniques such as injection molding or extrusion. It would thus be desirable to obtain a polyoxymethylene composition that has good fatigue resistance and good mechanical properties and that may be conveniently melt processed.

U.S. Pat. No. 6,384,179 discloses a polyacetal resin composition comprising a polyacetal copolymer (A) having a melt index of less than 1.0 g/10 min and a polyacetal copolymer (B) having a melt index of 1.0 to 100 g/10 min where the melting points of (A) and (B) are both 155 to 162° C. or the difference in melting point between (A) and (B) is less than 6° C.

### SUMMARY OF THE INVENTION

In one aspect, the present invention is a polyoxymethylene composition, comprising about 40 to about 90 weight percent of at least one polyoxymethylene homopolymer (A) having a number average molecular weight of at least about 100,000 and about 10 to about 60 weight percent of at least one polyoxymethylene homopolymer (B) having a number average molecular weight of between about 15,000 and about 30,000, wherein the weight percentages are based on the total weight of (A)+(B).

### DETAILED DESCRIPTION OF THE INVENTION

The compositions of the present invention comprise a melt-mixed blend comprising at least one polyoxymethylene homopolymer (A) having a number average molecular weight of at least about 100,000 and at least one polyoxymethylene homopolymer (B) having a number average molecular weight of between about 15,000 and 30,000. The compositions have good tensile properties and excellent fatigue and creep resistance.

Homopolymers are prepared by polymerizing formaldehyde and/or formaldehyde equivalents, such as cyclic oligomers of formaldehyde. It is preferred that the terminal hydroxy groups of the homopolymers are end-capped by a chemical reaction to form ester or ether groups. Preferred end groups for homopolymers are acetate and methoxy. The polyoxymethylene will preferably be linear (unbranched) or have minimal chain-branching.

Polyoxymethylene homopolymer (A) has a number average molecular weight of greater than 100,000, or preferably at least about 103,000, or more preferably of at least about 108,000. The number average molecular weight will still more preferably be in the range of greater than 100,000 to about 300,000. Polyoxymethylene (A) will preferably have a melt flow rate of about 0.5 g/10 min or less or more preferably about 0.4 g/10 min or less, or yet more preferably about 0.3 g/10 min or less, as measured at 190° C. under a 2.16 kg load, following ISO method 1133.

Polyoxymethylene homopolymer (A) may be prepared using any conventional method. It will be apparent to those skilled in the art that it will be necessary to ensure that the monomers and solvents used in the preparation of the polyoxymethylene be of sufficient purity to minimize the likelihood of chain-transfer reactions that would prevent the desired high molecular weights from being obtained during the polymerization. This will often require that the concentration of chain-transfer agents such as water and/or alcohols be kept to a minimum. See, for example, K. J. Persak and L. M. Blair, “Acetal Resins,” Kirk-Othmer Encyclopedia of Chemical Technology, 3^{rd} Edition, Vol. 1, Wiley, N.Y., 1978, pp. 112-123.

Polyoxymethylene homopolymer (B) has a number average molecular weight of about 15,000 to about 30,000, or preferably, about 18,000 to about 27,000. Polyoxymethylene (B) will preferably have a melt flow rate of about 15 g/10 min to about 50 g/10 min, or more preferably about 25 g/10 min to about 40 g/10 min, as measured at 190° C. under a 2.16 kg load, following ISO method 1133.

Number average molecular weight is determined by gel permeation chromatography using a light scattering detector.

Polyoxymethylene homopolymer (A) is present in about 40 to about 90 weight percent, or preferably in about 50 to about 80 weight percent, or yet more preferably in about 60 to about 70 weight percent, and polyoxymethylene homopolymer (B) is present in about 10 to about 60 weight percent, or preferably in about 20 to about 50 weight percent, or yet more preferably in about 30 to about 40 weight percent, where the weight percentages are based on the total amounts of (A)+(B).

Combined, the polyoxymethylene homopolymers (A) and (B) are preferably present in the composition in about 90 to 100 weight percent, or more preferably in about 95 to 100 weight percent, or yet more preferably in about 98 to 100 weight percent, based on the total weight of the composition.

The composition of the present invention may further optionally comprise at least one nucleating agent. Examples of suitable nucleating agents include, but are not limited to talc, calcium carbonate, and boron nitride. When used, the one or more nucleating agents are present in about 0.05 to about 0.5 weight percent, or preferably in about 0.1 to about 0.3 weight percent, based on the total weight of the composition.

The compositions of the present invention may optionally further comprise additives such as lubricants, processing aids, stabilizers (such as thermal stabilizers, oxidative stabilizers, ultraviolet light stabilizers), colorants, compatibilizers, tougheners, and fillers such as mineral fillers.

The compositions of the present invention are melt-mixed blends, wherein the polymeric components are well-dispersed within each other and the non-polymeric ingredients are well-dispersed in and bound by the polymer matrix, such that the blend forms a unified whole. Any melt-mixing method may be used to combine the polymeric components and non-polymeric ingredients of the present invention. For example, the polymeric components and non-polymeric ingredients may be added to a melt mixer, such as, for example, a single or twin-screw extruder; a blender; a kneader; or a Banbury mixer, either all at once through a single step addition, or in a stepwise fashion, and then melt-mixed.

The compositions of the present invention may be formed into articles using methods known to those skilled in the art, such as, for example, injection molding, blow molding, extrusion, thermoforming, melt casting, and rotational molding. The composition may be overmolded onto an article made from a different material. The composition may be extruded into films. The composition may be formed into monofilaments.

Examples of suitable articles include gears; rods; sheets; strips; channels; tubes; conveyor system components such as wear strips, guard rails, rollers, and conveyor belt parts. Other suitable articles are high pressure tubes, including those used in applications where they experience pressure cycles. Preferred are gears for automotive applications.

### EXAMPLES

The compositions of Examples 1 and 2 and Comparative Example 1 were prepared by melt compounding in a 30 mm co-rotating twin-screw extruder the ingredients shown in Table 1 and additives. The additives comprised 0.025 weight percent Acrawax® C (ethylene bis-stearamide; supplied by Lonza, Inc, Fairlawn, N.J.), 0.07 weight percent Irganoxe® 245 and 0.03 weight percent Irganox® 1098 (phenolic antioxidants; supplied by Ciba Specialty Chemicals Corp, Tarrytown, N.Y.), and 0.5 weight percent polyacrylamide, where the weight percentages are based on the total weight of the composition. The extruder barrel temperatures were maintained at about 190-210° C. and a 4 mm diameter die head was used to form strands that were cut into to 3 mm long pellets. The pellets were then injection molded into test specimens.

The following ingredients are used in the Examples and Comparative Example:

Polyoxymethylene A refers to a polyoxymethylene homopolymer having a number average molecular weight of about 108,000 and a melt flow rate of about 0.3 measured at 190° C. under a 2.16 kg load.

Polyoxymethylene B refers to a polyoxymethylene homopolymer having a number average molecular weight of about 26,000.

Polyoxymethylene C refers to a polyoxymethylene homopolymer having a number average molecular weight of about 66,000

Talc refers to Ultratalc® 609, available from Specialty Minerals Inc, Bethlehem, Pa.

Young's modulus, elongation at yield and elongation at break were measured on ASTM Type IV test specimens molded according to ASTM D 638. The results are given in Table 1.

Flexural modulus was measured in accordance with ASTM D 790-00 on Izod-Type test specimens molded as outlined in ASTM D 256. The results are given in Table 1.

Measurements of tensile fatigue were carried out on ASTM Type IV test specimens molded according to ASTM D 638 in a Universal Testing Machine equipped with a fatigue fixture. The tensile specimens were tested in a stress-controlled mode and subjected to a tensile stress varying sinusoidally between 0 and 44 MPa with a frequency of 10 Hz. Samples were run until failure due to fracture. For all the tests, the results were averaged over five specimens and the results are given in Table 1.

Accelerated creep testing was performed using a TA instruments DMA 983 using test specimens prepared like those for flexural modulus testing. Measurements were taken at 5° C. intervals from 25 to 130° C., inclusive. The samples were held at the test temperature for 30 minutes. A flexural load was applied to the sample and the creep (amount of deflection of the sample under the load) was monitored for 15 minutes. The load was then removed and the sample was then allowed to recover for 60 minutes, whereupon the testing temperature was increased by 5 degrees and the cycle was repeated. The resulting creep compliances at different temperatures were shifted to a reference temperature of 25° C. to obtain a master curve spanning about 100,000 hours. The degree of creep expected after 1,000 and 100,000 hours was determined from the curve and the results are shown in Table 1.

TABLE 1

| | Ex. 1 | Ex. 2 | Comp. Ex. 1 |
|---|---|---|---|
| Polyoxymethylene A | 66.4 | 66.3 | — |
| Polyoxymethylene B | 30 | 30 | — |
| Polyoxymethylene C | — | — | 100 |
| Talc | — | 0.1 | — |
| Young's modulus | 3400 | 3600 | 3200 |
| (MPa) | | | |
| Flexural modulus | 3100 | 3150 | 2900 |
| (MPa) | | | |
| Elongation at yield (%) | 23 | 12 | 14 |
| Elongation at break | 47 | 44 | 40 |
| (%) | | | |
| Tensile fatigue life | 7668 | >2.6 × 10⁶ | 4048 |
| (cycles to failure) | | | |
| Creep | | | |
| After 1,000 h (%) | 1.37 | 1.22 | 1.49 |
| After 100,000 h (%) | 2.04 | 1.83 | 2.28 |

All ingredient quantities are in weight percent, based on the total weight of the composition.

What is claimed is:

1. A polyoxymethylene composition, comprising about 40 to about 90 weight percent of at least one polyoxymethylene homopolymer (A) having a number average molecular weight of at least about 100,000 and about 10 to about 60 weight percent of at least one polyoxymethylene homopolymer (B) having a number average molecular weight of between about 15,000 and about 30,000, wherein the weight percentages are based on the total weight of (A)+(B).

2. The composition of claim 1 further comprising at least one nucleating agent.

3. The composition of claim 2, wherein the nucleating agent is one or more selected from the group consisting of talc, calcium carbonate, and boron nitride.

4. The composition of claim 1, wherein polyoxymethylene homopolymer (A) has a number average molecular weight of at least about 103,000.

5. The composition of claim 1, wherein polyoxymethylene homopolymer (A) has a number average molecular weight of at least about 108,000.

6. The composition of claim 1, wherein polyoxymethylene homopolymer (B) has a number average molecular weight of about 18,000 to about 27,000.

7. The composition of claim 1, wherein polyoxymethylene homopolymer (A) is present in about 50 to about 80 weight percent and polyoxymethylene homopolymer (B) is present it about 20 to about 50 weight percent, based on the total weight of (A)+(B).

8. The composition of claim 1, wherein polyoxymethylene homopolymer (A) is present in about 60 to about 70 weight percent and polyoxymethylene homopolymer (B) is present it about 30 to about 40 weight percent, based on the total weight of (A)+(B).

9. The composition of claim 1, wherein polyoxymethylene homopolymer (A) has a melt flow rate of less than or equal to about 0.5 g/10 min, wherein said melt flow rate is determined using ISO Method 1133 measured at 190° C. under a 2.16 kg load.

10. The composition of claim 1, wherein polyoxymethylene homopolymer (A) has a melt flow rate of less than or equal to about 0.4 g/10 min, wherein said melt flow rate is determined using ISO Method 1133 measured at 190° C. under a 2.16 kg load.

11. The composition of claim 1, wherein polyoxymethylene homopolymer (B) has a melt flow rate of about 15 g/10 min to about 50 g/10 min, wherein said melt flow rate is determined using ISO Method 1133 measured at 190° C. under a 2.16 kg load.

12. The composition of claim 1, wherein polyoxymethylene homopolymer (B) has a melt flow rate of about 25 g/10 min to about 40 g/10 min, wherein said melt flow rate is determined using ISO Method 1133 measured at 190 ° C. under a 2.16 kg load.

13. The composition of claim 1, further comprising at least one lubricant, at least one processing aid, at least one stabilizer, at least one colorant, at least one compatibilizer, at least one toughener, at least one filler, or a combination thereof.

14. An article comprising the polyoxymethylene composition of claim 1.

15. The article of claim 14 in the form of a gear.

16. The article of claim 14 in the form of a rod, sheet, strip, channel, or tube.

17. The article of claim 14 in the form of a conveyor system component.

18. The article of claim 14 in the form of a high pressure tube.
